(19) United States
(12) Patent Application Publication
(10) Pub. No.: US 2014/0358050 A1
(43) Pub. Date: Dec. 4, 2014

(54) Therapy Device, and Method

(71) Applicants: Clifford A. Stock, Lee's Summit, MO (US); Steven Perry, Lee's Summit, MO (US)

(72) Inventors: Clifford A. Stock, Lee's Summit, MO (US); Steven Perry, Lee's Summit, MO (US)

(21) Appl. No.: 14/181,232

(22) Filed: Feb. 14, 2014

Related U.S. Application Data
(60) Provisional application No. 61/830,845, filed on Jun. 4, 2013.

(51) Int. Cl. A61H 15/00

(52) U.S. Cl. CPC A61H 15/0092
USPC 601/119

(57) ABSTRACT

The application depicts a therapy device, and also depicts a method of providing therapy that incorporates the inventive therapy device. The device includes a first and second rolling means mounted on a bar. The method includes the steps of using a therapy device that has a first and second rolling means mounted to a bar by moving the device along a selected area, preferably adjacent a spinal column.

### SUMMARY OF THE INVENTION

The invention is a therapy device for muscles and tissue, and the invention is also a method of providing therapy to a selected area of muscles and tissue.

### The Therapy Device

The inventive therapy device includes a first end, a central portion, and a second end, the central portion being aligned with a longitudinal axis. The first end and second end extend symmetrically from the central portion and may be aligned with the longitudinal axis; alternatively, each may angled relative the longitudinal axis.

The invention also includes a first rolling means positioned on the central portion and rotatable about the longitudinal axis, as well as a second means positioned on the central portion. Each is rotatable about the longitudinal axis, and the second rolling means displaced from the first rolling means to allow a void between the first rolling means and second rolling means. Handgrips are positioned adjacent the ends of the device.

In a preferred embodiment of the inventive therapy device, the first rolling means is at least one wheel rotatably mounted about the longitudinal axis. In like manner, the second rolling means may also include at least one wheel rotatably mounted about the longitudinal axis. In preferred embodiments, each of the first and second rolling means may include a pair of adjacent wheels. Preferably, each wheel is rotatably mounted about the central portion such that it may be independently rotatable about the central portion such that each wheel may rotate at its own angular speed.

In a preferred embodiment, the rolling means are each selectively positionable at a chosen locations along the longitudinal axis. In order to accomplish this, each rolling means may be equipped with a bearing that can grip the central portion at a selected location, yet meanwhile allow selective rotation of the rolling means about the central portion.

### The Therapy Method

The invention is also a method of giving therapy to muscles and tissue. The method includes the step of providing handlebar having a first end, a central portion, and a second end. The central portion, the first end, and second end each extend from the central portion and are preferably aligned with the longitudinal axis. Alternatively, the first and second ends may be symmetrically angled relative the longitudinal axis.

The therapy method also includes the step of positioning a first rolling means on the central portion, and enabling the first rolling means to be rotatable relative the longitudinal axis, and the step of positioning a second rolling on the central portion, and enabling the second rolling means to be rotatable relative the longitudinal axis.

The inventive method also requires one to position the second rolling means at a location displaced from the first rolling means, thereby maintaining a void between the first rolling means and second rolling means. There is a primary handgrip adjacent the first end of the handlebar, and a secondary handgrip adjacent the second end. Of course, the inventive therapy method also includes the step of engaging the first rolling means and second rolling means with a chosen area of a person, gripping the primary and secondary handgrips, and moving the first and second rolling means back and forth along the muscles and tissue in a direction generally orthogonal the longitudinal axis.

In a preferred embodiment, the rolling means each comprise a pair of adjacent wheels rotatably mounted about the longitudinal axis, and each may be selectively positioned at a chosen location along the central portion.

The therapy method works well on the tissues adjacent the spinal column of a person. In this embodiment of the therapy method, the invention includes the steps positioning the first rolling means on a first side of the spine and the second rolling means on the second side of the spine.

In order to accommodate the personal preference of the person receiving the therapy, the method may include the step of providing a choice of first and second rolling means that have varying degrees of hardness.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a perspective view of the therapy device, according to the principles of the invention.

FIG. 2 shows a perspective view of the therapy device, shown with the first rolling means spaced apart from a second rolling means.

FIG. 3 is an exploded and perspective view of the therapy device, according to the principles of the invention.

FIG. 4 presents an isolated, perspective and exploded view detailing the wheel, wheel hubs, rod, and spacers.

### DETAILED DESCRIPTION OF THE PREFERRED EMBODIMENTS

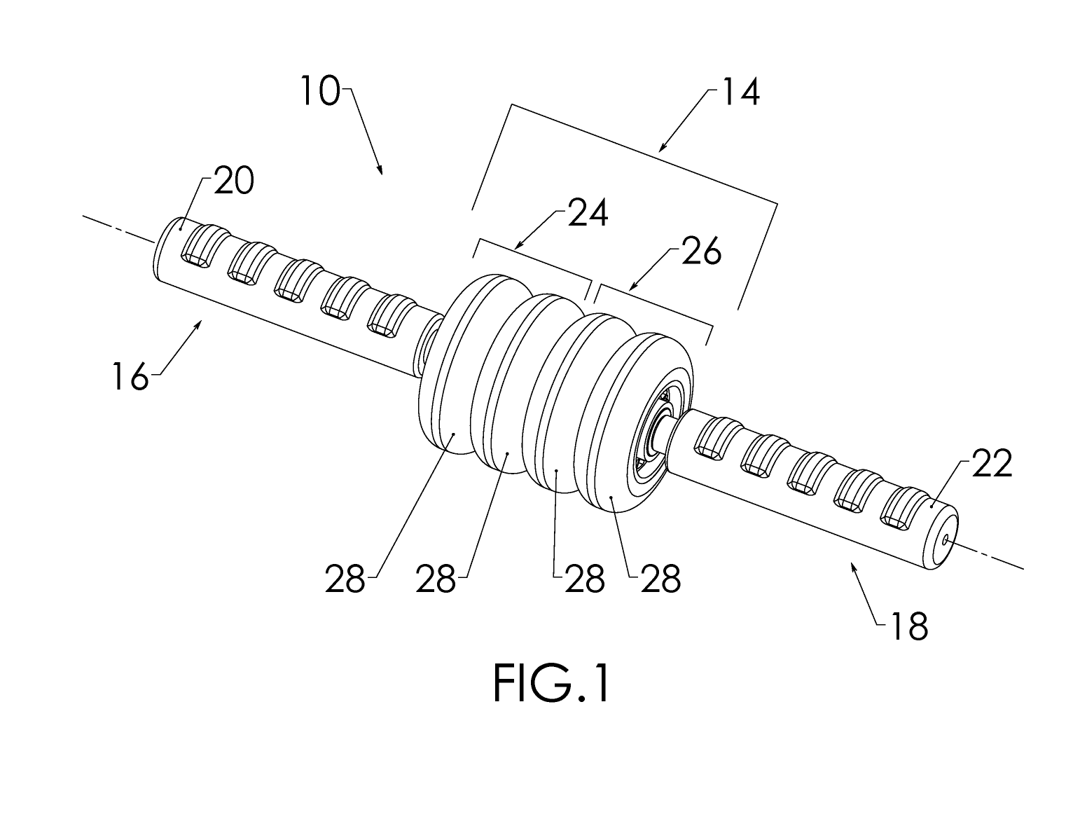

FIG. 1 shows a perspective view of the therapy device 10, according to the principles of the invention. The therapy device 10 has a first end 16, a second end 18, and a central portion 14 coinciding with a longitudinal axis L. The first end 16 and second end 18 are disposed at opposing ends of the central portion 14 of the device 10. A first handgrip 20 is adjacent the first end 16 and a second handgrip 22 is adjacent the second end 18.

Still referring to FIG. 1, the device 10 further includes a first rolling means 24 and a second rolling means 26. Each rolling means 24, 26 is positioned on the central portion 14. As shown in FIG. 1, the first rolling means 24 includes a pair of adjacent wheels 28; analogously, the second rolling means 26 also includes a pair of adjacent wheels 28.

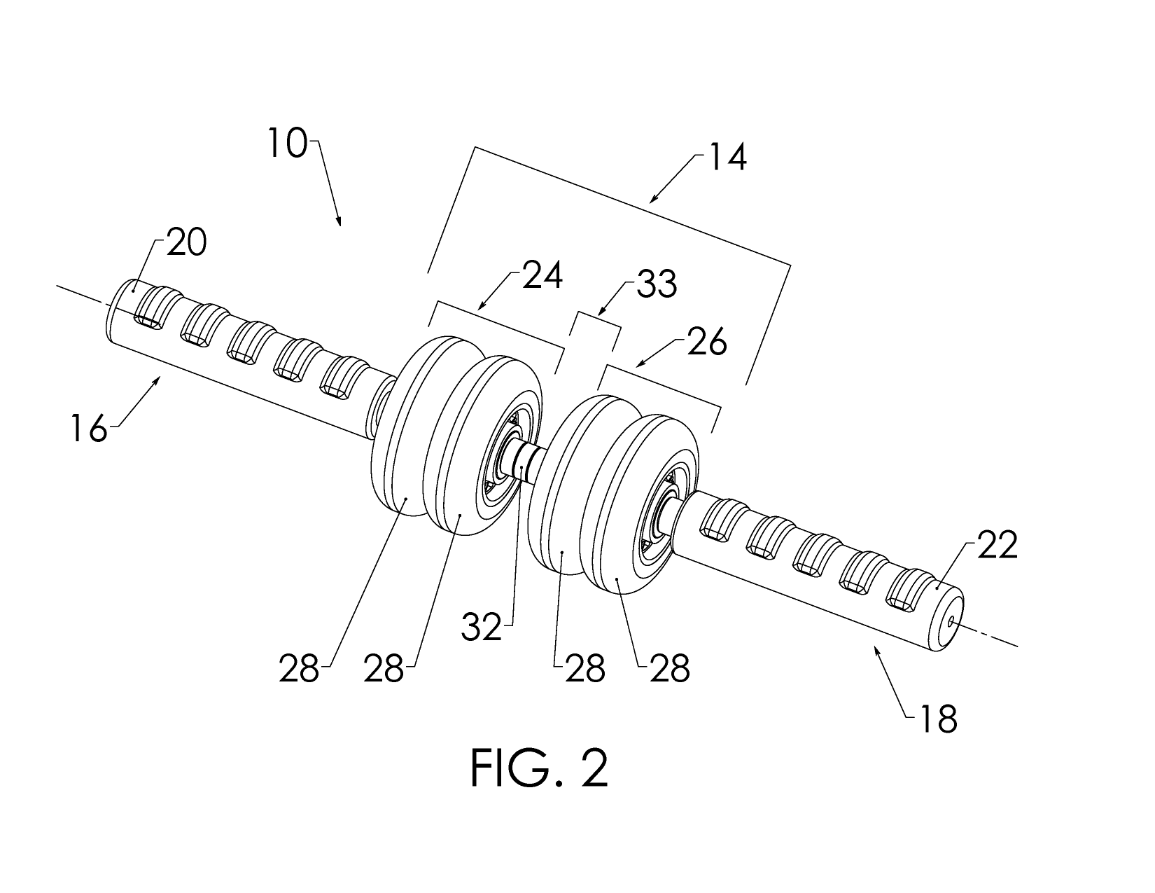

In this embodiment, a rod (viewable in FIG. 2) passes through the central portion 14 and is removably connectable to the first end 16 so that the wheels may be positioned at preselected locations along the central portion 14.

One can use the therapy device shown in FIG. 1 by grabbing the handgrips 20, 22 and rolling the device 10 along a selected area using an amount of pressure that suits the personal preference of the person. Although FIG. 1 depicts all wheels 28 adjacent one another, a preferred embodiment of the device 10 allows the wheels 28 to be spaced apart from one another on the central portion 14 of the device 14 (shown aft).

Use of the device 10 stimulates endorphin release, which is the body's natural pain reliever. As such, the use of the device 10 creates the feel-good sensation of overall well-being. While the device 10 is well-suited to be used along the spine of a person, the device 10 has proven an effective tool for providing therapy to other major muscle groups such as quads, hamstrings, glutes, calves, and traps, etc. And while a preferred method of using the device 10 is by having one provide therapy to another, the device can be used by one person without the assistance of another. For example the device may be anchored to a wall or floor, and a user may engage against the device 10 and move one's body against the device in order to achieve similar release of myofascial tension.

Still referring to FIG. 1, the central portion 14 may include a rod that is pliable, allowing some flexion in the central portion 14. Thus, the central portion 14 may have some give to it that prevents one from using the device in a way that would apply excessive amounts of downward force. Although the figures herein show an embodiment wherein each of the first rolling means 24 and the second rolling means 26 includes a pair of adjacent wheels 28, one may adjust the device 10 wherein each rolling means 24,26 comprises a single wheel 28.

FIG. 2 shows a perspective view of a second embodiment of the therapy device 10, according to the principles of the invention. As in the prior embodiment, the therapy device 10 has a first end 16, a second end 18, and a central portion 14 coinciding with a longitudinal axis L. Analogously, the first end 16 and second end 18 are disposed at opposing ends of the central portion 14 of the device 10. Moreover, first handgrip 20 is adjacent the first end 16 and a second handgrip 22 is adjacent the second end 18.

Still referring to FIG. 2, the device 10 further includes a first rolling means 24 and a second rolling means 26, each positioned on the central portion 14. As with the previously discussed embodiment, the embodiment shown in FIG. 2 includes a pair of adjacent wheels 28 for each of the first rolling means 24 and second rolling means 26, analogously, the second rolling means 26 also includes a pair of adjacent wheels 28.

In this embodiment shown in FIG. 2, a rod (viewable aft) passes through the central portion 14 and is removably connectable to the first end 16 so that the wheels may be positioned at preselected locations along the central portion 14. As shown in FIG. 2, the first rolling means 24 may be displaced from the second rolling means 26 by mounting spacers 32 along the rod (viewable aft) between the wheels 28, thereby creating a void 33 between the first rolling means 24 and the second rolling means 26.

Preferably the therapy device shown in FIG. 2 is used by grabbing the handgrip 20, 22 and rolling the device 10 along a selected area using an amount of pressure that suits the personal preference of the person. In this embodiment, one preferably engages the first rolling means 24 along a first side of a person's spine and engages the second rolling 26 along the opposing side of a person's spine so that the void 32 is directly above the person's backbone.

Once the device 10 shown in FIG. 2 is positioned as described, then one rolls the device along the spinal column at a desired pressure in order to give soothing release to the myofascial tissue adjacent the person's spine.

While the device 10 shown herein is well-suited to be used along the spine of a person, the device 10 has proven an effective tool for providing therapy to other major muscle groups such as quads, hamstrings, glutes, calves, and traps, etc. And while a preferred method of using the device 10 is by having one provide therapy to another, the device can be used by one person without the assistance of another.

For example the device may be anchored to a wall or floor, and a user may engage against the device 10 and move one's body against the device in order to achieve similar release of myofascial tension.

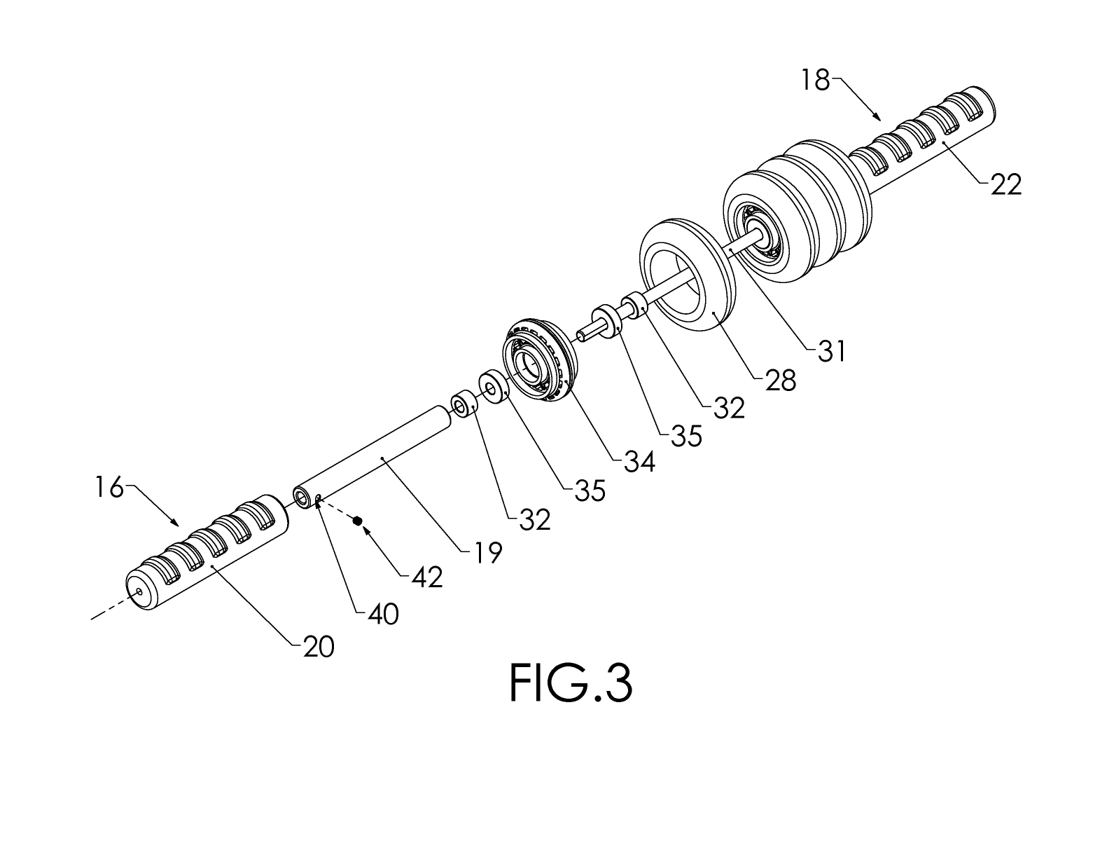

FIG. 3 shows an exploded and perspective view of the device 10, and details the various component parts. A first handgrip 20 is removably positionable around a hollowed handle 19 positioned at the first end 16; in like manner a second handgrip 22 is positionable around the second end 18. The hollowed handle 19 and the rod 31 are cooperatively formed so that the rod 31 can slide into the interior of the hollowed handle 19 when the device 10 is fully assembled.

When the components shown in FIG. 3 are fully assembled (as in FIGS. 1, 2), the terminus of the rod 31 slides within and becomes adjacent the end of the hollow handle 19. The hollow handle 19 bears a threaded aperture 40 formed to receive a set screw 42. When the wheels 28 are positioned along the rod 31 at desired locations, one inserts the rod 31 into the hollowed handle 19, then inserts and lightens the set screw 42 into the aperture 40 in order to affix the hollowed handle 19 to the rod 31.

As shown in FIG. 3, the wheels 28 are rotatably mounted to the rod 31 that passes through the therapy device 10. The rod 31 is preferably pliable so that the device 10 is not rigid in response to increased pressure applied when the therapy device 10 engages a selected area. Each wheel 28 comprises a special wheel hub 34 that enables each wheel 28 to rotate independently of the other wheels. The wheel hub 34 is formed to accommodate bearing 35 that enables rotation relative the rod 31. The wheel hub 34 also enables one to choose a selected location along the rod 31. In this way, one may position the wheels 28 adjacent one another (as in FIG. 1), or spaced from one another (as in FIG. 2), in order to meet personal preference.

Still referring to FIG. 3, a plurality of spacers 32 may be mounted along the rod 31 between the bearings 35 of the wheel hubs 34. For example, if one desires wheels 28 to be near one another along rod 31 (as in FIG. 1, for example) a user may mount only one spacer 32 between adjacent bearings 35. However, if a greater amount of space is desired (as in FIG. 2, for example), one may mount several spacers 32 on the rod 31 between adjacent bearings 35. When the desired position of the wheels 28 is achieved, the rod 31 is inserted within the hollow handle 19, then affixed the hollow handle 19 is affixed to the rod 31 using the set screw 40. Once the set screw 40 is tightened down to engage the rod 31, the handgrip 20 slides over the hollow handle 19 and the device 10 is ready for use.

Still referring to FIG. 3, the adjustability of the spacing of the wheels allows to fit anyone's width of their spinous process while applying pressure to their “Para-vertebral muscles” that cover the transverse process of the vertebrae. The ends 16, 18 include a set screw, which enables one to position the wheels 28 along the rod 31 that passes through central portion 14.

In a preferred embodiment, the wheel hub 34 is equipped with wheel SG-5 ball bearings, which enable the wheels 28 to freely rotate about the rod 31 independently from each other so the recipient has no skin abrading during the rolling process.

Still referring to FIG. 3, the wheels 28 may include a pliable material that can be manufactured of varying hardness. It has been found that urethane of 15 durometer provides proper feel for delicate muscle tissue, and urethane of 30 durometer hardness works well with more dense muscle tissue that would require greater force for myofascial release. The claimed invention is best suited for use of a new urethane polymer created specifically for the wheels 28 of the therapy device, having a degree of hardness that allows manufacture by injection molding.

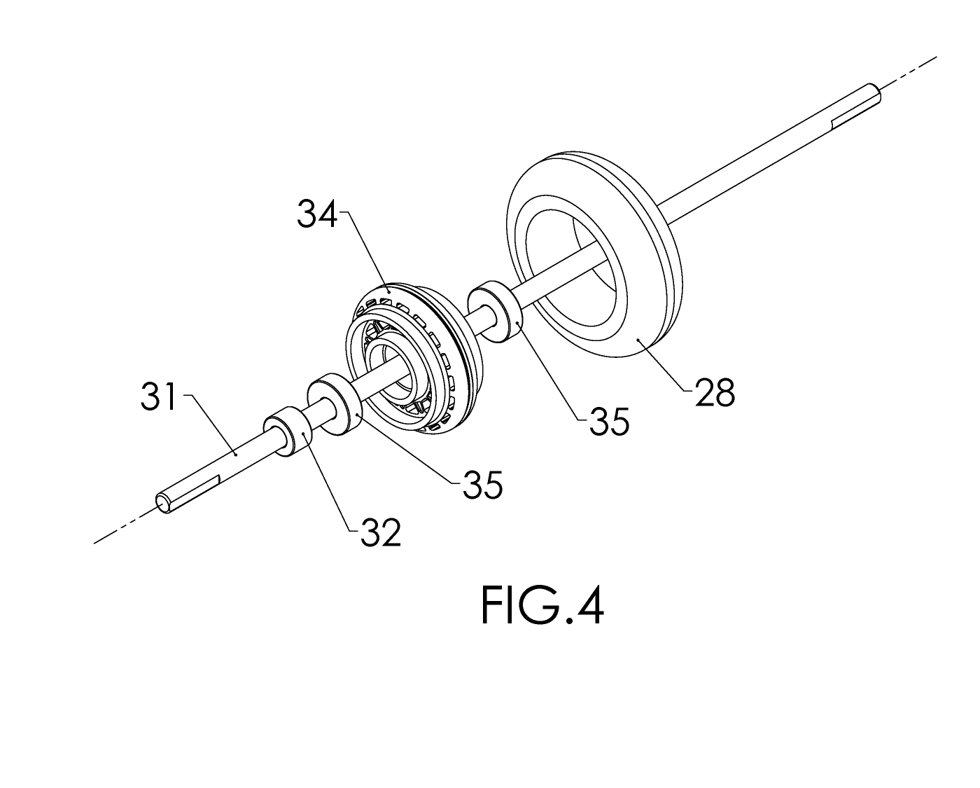

FIG. 4 presents an isolated and perspective view that details the way the component parts of the central portion 14 (see FIG. 1) are cooperatively formed. The wheel hub 34 is formed to receive bearing 35 adjacent the inner portion of the wheel hub 34. The pliable (preferably urethane) wheel 28 then snugly envelops the wheel hub 34. Preferably, the wheel 28 is removable from the wheel hub 14, enabling a user to selectively replace a wheel 28 having varying differing durometer hardness. Alternatively, the wheel hub 34 and the wheel 28 may be formed as a unitary, monolithic one-piece structure.

As shown in FIG. 4, the rod 31 passes through each bearing 35 and each spacer 32. In a preferred embodiment, the rod 31 comprises a 5/16 inch diameter steel axle, and fits within the hollow center of a ⅝ inch aluminum hollow handle 19 (see FIG. 3).

FIG. 5 shows a perspective view of the therapy device 10 being used along the spine of a person. As shown, one grips the therapy device 10 using handgrips 20, 22 positioned adjacent opposing ends of wheels 28. The therapy device 10 is positioned to engage adjacent a person's spine so that one set of wheels 28 is on a first side of the spine, and another set of wheels 28 is on a second side of the spine, comprising the step of positioning the void adjacent the spine such that the first rolling means engages on a first side of the spine and the second rolling means engages on the second side of the spine. Next, the wheels 28 of the therapy device 10 are rolled up and down along the spine of a person, with pressure applied to the handgrips 20, 22 adjusted to suit the person.

Having described and illustrated the invention in detail, it is to be understood that the above and foregoing is for illustration and demonstration only. The descriptions herein are not intended to limit the breadth of this invention, and the scope of the invention shall be defined and limited by the claims herein.

Our invention is:

1. A therapy device comprising:
a first end, a central portion, and a second end, the central portion being aligned with a longitudinal axis and the central portion including a rod aligned with the longitudinal axis, the rod having an initial point engaging the first end and a terminus engaging the second end;
a first rolling means rotatably mounted to the rod;
a second rolling means rotatably mounted to the rod;
a primary handgrip positioned adjacent the first end and a secondary handgrip positioned adjacent the second end; wherein, the second rolling means is selectively positionable at a preselected point along the rod.

2. The therapy device as in claim 1, the first rolling means comprising at least one wheel rotatably mounted to the rod.

3. The therapy device as in claim 2, wherein the first rolling means comprises two wheels rotatably mounted to the rod.

4. The therapy device as in claim 3, wherein the first rolling means includes a first wheel and a second wheel, and wherein the first wheel is rotatable relative the second wheel.

5. The therapy device as in claim 1, the second rolling means comprising at least one wheel that is rotatably mounted to the rod.

6. The therapy device as in claim 5, wherein the second rolling means comprises two wheels rotatably mounted to the rod.

7. The therapy device as in claim 6, the second rolling means comprising a first wheel and a second wheel, and wherein the first wheel is rotatable relative the second wheel.

8. The therapy device as in claim 1, wherein the first rolling means is selectively positionable along the rod.

9. The therapy device as in claim 1, the first rolling means having an inner bearing that enables rotation of the first rolling means relative the rod and further enables selective positioning of the first rolling means at a chosen location along the rod.

10. The therapy device as in claim 1, wherein the second rolling means is selectively positionable at a chosen location along the rod.

11. The therapy device as in claim 1, further comprising a hollow handle; and wherein, the rod is formed to engage within an interior of the hollow handle.

12. A method of giving therapy to a selected area, the method including including the steps of:
providing a first end, a central portion, and a second end, the central portion being aligned with a rod that defines a longitudinal axis;
positioning a first rolling means on the central portion and rotatably mounted to the rod;
positioning a second rolling on the central portion and rotatably mounted the rod;
positioning a primary handgrip adjacent the first end;
positioning a secondary handgrip adjacent the second end;
gripping the primary and secondary handgrips, and engaging the first and second rolling means on a selected area; and,
moving the first and second rolling means back and forth along in a direction generally orthogonal the longitudinal axis.

13. The therapy method as in claim 12, the first rolling means having two wheels rotatably mounted about the rod.

14. The therapy method as in claim 12, the second rolling means comprising at least one wheel that is rotatably mounted about the rod.

15. The therapy method as in claim 12, further including the step of positioning the second rolling means at a location on the rod displaced from the first rolling means, thereby maintaining a void between the first rolling means and second rolling means.

16. The therapy method as in claim 15, the area being a spine including aligned vertebrae of a person, and further comprising the step of positioning the void adjacent the spine such that the first rolling means engages on a first side of the spine and the second rolling means engages on the second side of the spine.

17. The therapy method as in claim 12, further comprising the step of providing first and second rolling means that have varying degrees of hardness.

18. The therapy method as in claim 12, further comprising the step of selectively positioning the first rolling means to a chosen mounting position on the central portion.

19. The therapy method as in claim 12, further comprising the step of
positioning at least one spacer on the rod between the first rolling means and the second rolling means.

20. The therapy method as in claim 12, further comprising the steps of
providing a hollow handle that is cooperatively formed to envelop the rod;
inserting the rod into an interior of the hollow handle;
forming a threaded aperture adjacent a terminal end of the hollow handle;
passing a set screw through the threaded aperture to engage the rod.
